(19) United States
(12) Patent Application Publication
(10) Pub. No.: US 2007/0029934 A1
(43) Pub. Date: Feb. 8, 2007

(54) Plasma display panel

(76) Inventors: Ki-Dong Kim, Chunan-si (KR); Yong-Su Park, Chunan-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/498,605

(22) Filed: Aug. 2, 2006

(30) Foreign Application Priority Data
Aug. 3, 2005 (KR) 10-2005-0071078
Aug. 3, 2005 (KR) 10-2005-0071079

(51) Int. Cl. H01J 17/49

(52) U.S. Cl. 313/586

(57) ABSTRACT

A plasma display panel (PDP) is disclosed. In one embodiment, the PDP includes i) first and second substrates spaced apart from each other, wherein an image is configured to be displayed via the second substrate, ii) a plurality of discharge cells formed between the first and second substrates and iii) a protective layer formed between the plurality of discharge cells and the second substrate. In one embodiment, the protective layer is formed form MgO and dopant, wherein the concentration of the dopant gradually increases in the thickness direction.

### CROSS-REFERENCES TO RELATED APPLICATION

This application claims priority to and the benefit of Korean Patent Application Nos. 10-2005-0071078 and 10-2005-0071079 filed in the Korean Intellectual Property Office on Aug. 3, 2005, the entire contents of which are incorporated herein by reference.

### BACKGROUND OF THE INVENTION

1. Field of the Invention

The present invention relates to a plasma display panel (PDP). More particularly, the present invention relates to a PDP having a protective layer that can improve discharge and life-span characteristics by varying the composition of the protective layer.

2. Description of the Related Technology

The PDP has been spotlighted as one of a next-generation thin display device since it can realize a large-sized screen while providing high-resolution images. Generally, the PDP displays an image by exciting phosphors with vacuum ultraviolet radiation generated from plasma which is obtained through a gas discharge. The image is displayed by applying a predetermined voltage to two electrodes included in the PDP. The gas discharge is induced between the two electrodes and then plasma is obtained. The ultraviolet radiation is generated from the plasma and it excites a phosphor layer.

Generally, the PDP can be divided into three categories, an alternating current (AC) type, a direct current (DC) type, and a hybrid type. Among them, an AC type PDP is most widely used.

In the AC type PDP, display electrodes and address electrodes are arranged in a direction to cross each other. These electrodes are formed on substrates and a plurality of discharge cells are defined by a plurality of barrier ribs. Phosphors are formed in the discharge cells. A discharge gas is filled in each discharge cell. The display electrodes are covered with a dielectric layer in order to form wall charges. The dielectric layers can be damaged by a collision with electrons generated from the gas discharge. As a result, the life-span of the AC type PDP is shortened.

In order to protect the dielectric layer from the ion bombardment during the gas discharge, a protective layer is formed on the dielectric layer. The thickness of the protective layer is about hundreds of nanometers (nm).

The protective layer is usually made of MgO. The MgO protective layer can extend the life-span of the AC type PDP by reducing a discharge voltage and preventing the dielectric layer from being damaged by ion sputtering. However, it is not easy to form a protective layer having a uniform thickness since its property is subject to change depending on film growing conditions during heat deposition. As a result, the display quality of the PDP may not be consistent.

If the MgO protective layer is used, black noise phenomenon may occur due to an address discharge delay or an address error. In this phenomenon, a selected cell, which was supposed to emit light, does not operate. The black noise may occur in a certain region. Specifically, it easily occurs in the boundary between a light emitting region and a region where no light is emitted. The address error occurs when there is no address discharge. Furthermore, it may occur even when a weak scan discharge occurs.

The above information disclosed in this Background section is only for enhancement of understanding of the background of the invention. Therefore it may contain information that does not form the prior art that is already known in this country to a person of ordinary skill in the art.

### SUMMARY OF CERTAIN INVENTIVE ASPECTS

One aspect of the present invention provides a PDP including a protective layer capable of realizing stable discharge and excellent life-span without deteriorating secondary electron emission characteristics. The protective layer includes MgO and an element selected from the group consisting of Ca, Fe, and a combination thereof. The content of the selected element varies in the protective layer. The concentration gradient of the element is positive from a surface of the protective layer toward the dielectric layer.

Another aspect of the present invention provides a PDP capable of controlling a discharge cell to perform improved gas discharge.

One embodiment of the present invention provides a PDP including i) first and second substrates spaced apart from each other in a parallel manner with a predetermined distance therebetween, ii) a plurality of address electrodes disposed on the first substrate, iii) a first dielectric layer disposed on the first substrate while covering the address electrodes, iv) a plurality of barrier ribs formed on the first dielectric layer configured to partition a space between the first and second substrates into a plurality of discharge cells, v) phosphor layers formed in the discharge cells, vi) a plurality of display electrodes disposed on the second substrate along a direction to cross the address electrodes, vii) a second dielectric layer disposed on the second substrate to cover the display electrodes, and viii) a protective layer disposed to cover the second dielectric layer. The protective layer includes MgO and an element selected from the group consisting of Ca, Fe, and a combination thereof. The surface of the protective layer contacts the discharge cells.

Another aspect of the present invention includes a plasma display panel including i) first and second substrates spaced apart from each other, ii) a plurality of discharge cells formed between the first and second substrates, and iii) a protective layer formed between the plurality of discharge cells and the second substrate. In one embodiment, the protective layer is formed from MgO and dopant, and wherein the content of MgO decreases in a thickness direction from the plurality of the discharge cells to the second substrate. The dopant includes at least one of Ca and Fe.

Another aspect of the present invention includes i) providing a substrate, ii) providing a plurality of electrodes on the substrate, iii) providing a dielectric layer configured to cover the plurality of electrodes, and iv) providing a protective layer on the dielectric layer. The providing may include depositing materials comprising MgO and dopant on the dielectric layer while gradually decreasing contents of the dopant. The dopant may include at least one of Ca and Fe. The depositing may include i) depositing MgO and at least one of Ca and Fe and ii) depositing MgO and at least one of Si, Al, Fe, Cr and Na.

### BRIEF DESCRIPTION OF THE DRAWINGS

FIG. 1 is a partial perspective view of the PDP in accordance with an embodiment of the present invention.

FIG. 2 is a perspective view of an upper substrate of the PDP in accordance with an embodiment of the present invention.

FIG. 3 is a graph showing the content of Ca varying in accordance with the depth from the surface of the protective layer.

FIG. 4 is a graph showing the content of Ca in accordance with the depth from the surface of the protective layer in the form of an equation.

FIG. 5 is a graph showing life-span characteristics of PDPs of Examples 1 and 2 and Comparative Examples 1 and 2.

FIG. 6 is a graph showing discharge characteristics of PDPs of Examples 1 and 2 and Comparative Examples 1 and 2.

FIG. 7 is a graph showing the content of Fe in accordance with the depth from the surface of the protective layer.

FIG. 8 is a graph showing the content of Fe in accordance with the depth from the surface of the protective layer in the form of an equation.

FIG. 9 is a graph showing life-span characteristics of PDPs of Examples 5 and 6 and Comparative Examples 1 and 3.

FIG. 10 is a graph showing discharge characteristics of PDPs of Examples 5 and 6 and Comparative Examples 1 and 3.

### DETAILED DESCRIPTION OF CERTAIN INVENTIVE EMBODIMENTS

One embodiment of the present invention provides a PDP including a protective layer that can improve display quality by preventing a black noise which may be caused by an address error.

One embodiment of the present invention provides the a protective layer having a uniform thickness The protective layer can protect the dielectric layer from the ion bombardment during a discharge period.

In one embodiment, the protective layer includes MgO and an element. (dopant) The dopant may include at least one of Ca and Fe. The content (amount) of a selected element varies along the direction of the thickness, namely, the depth of the protective layer (i.e. toward the front substrate). In one embodiment, the amount increases in the depth direction.

The content of the selected element may be represented by Equation 1 below.
Y=aX+b Equation 1

where Y denotes the content of the element, X denotes the thickness of the protective layer, and “a” and “b” are constants. “a” may be in the range of about 11 to about 14, or from about 11.5 to about 13.8, and “b” may be in the range of about 145 to about 160. The distance is measured along a direction substantially perpendicular to the surface of the protective layer.

According to an embodiment of the present invention, the content of the element is in the range of about 20 ppm to about 400 ppm with respect to the entire amount of the protective layer. It may be in the range of about 20 ppm to about 250 ppm. If the content of the element is beyond this range, a response rate may be decreased and thus an address error may occur.

If the element includes Ca, the content of Ca may be in the range of about 150 ppm to about 400 ppm with respect to the entire amount of the protective layer, or about 150 ppm to about 250 ppm. If the element includes Fe, the content of Fe is in the range of about 20 ppm to about 40 ppm with respect to the entire amount of the protective layer, or about 20 ppm to about 30 ppm.

In an embodiment, the protective layer is formed of a thin film having electron emission characteristics. The thickness of the protective layer may be in the range of about 500 nm to about 900 nm. In an embodiment, the protective layer may have permeability of more than about 90%, or about 90% to about 97%. Its refractive index may be in the range of about 1.45 to about 1.74 when the thickness of the protective layer is about 640 nm.

In one embodiment, the protective layer is formed of MgO having anti-sputtering characteristics and has a large secondary electron emission coefficient. MgO included in the protective layer may be formed from a sintered material, for example, including a polycrystalline magnesium oxide. Alternatively, it may be formed from a single crystal. In one embodiment, the sintered material is used rather than the single crystal because a certain amount of the dopant can be solved in the protective layer.

The protective layer may be formed by using a deposition method. The protective layer may be formed by using a plasma deposition method while quantitatively adding the dopant after a sintered material or a material for forming the protective layer is prepared. Alternatively, a thick film printing method may be used by using a paste. A protective layer formed by the deposition method can resist against ion bombardment sputtering. It can reduce a firing voltage and a sustain voltage by secondary electron emission.

The deposition method may include sputtering, electron beam deposition, ion beam assisted deposition (IBAD), ion plating, magnetron sputtering, chemical vapor deposition (CVD), physical vapor deposition, plasma enhanced chemical vapor deposition, heat deposition, vacuum deposition and so on. Especially, a protective layer formed by the ion plating method may have excellent characteristics.

In addition, the protective layer may include a columnar crystalline structure. Although there is a difference in a growing direction, the columnar crystalline structure has excellent discharge and anti-sputtering characteristics compared to an amorphous protective layer. Therefore, in one embodiment, the protective layer is prepared by inducing crystalline growth.

The protective layer may include first and second protective layers. The second protective layer is formed on the first protective layer. As a dopant, the first and second protective layers may include an element whose content varies along a width direction of the protective layer. A concentration gradient of the element in the second protective layer may be positive from a surface of the protective layer, contacting the discharge cell, toward the second dielectric layer.

The first protective layer may include at least one of the following elements: Ca and Fe. The second protective layer may include at least one of the following: Si, Al, Fe, Cr and Na.

Since the protective layer has such a concentration gradient, it can maintain stable discharge characteristics even when the protective layer is sputtered by an ion bombardment during an address discharge. In addition, the secondary electron emission characteristics of the protective layer is not deteriorated. Furthermore, the life-span of the PDP is lengthened.

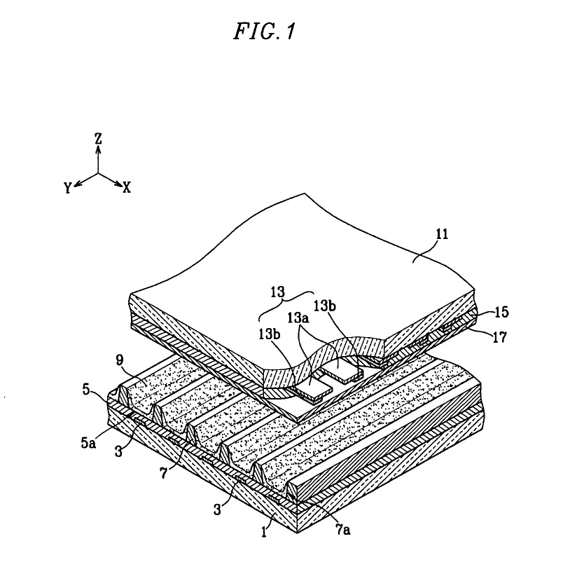

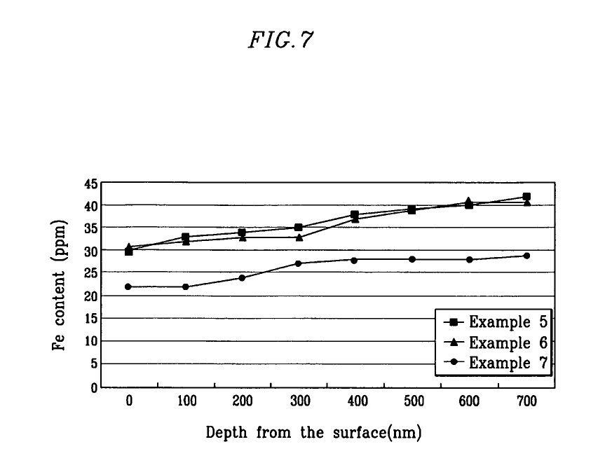

Hereinafter, embodiments of the present invention will be described with reference to FIGS. 1 to 10.

FIG. 1 is a partial perspective view of a PDP in accordance with an embodiment of the present invention.

Referring to FIG. 1, the PDP includes a first substrate 1, a plurality of address electrodes 3 disposed in a Y-axis direction on the first substrate 1, and a dielectric layer 5 disposed on the entire surface of the first substrate 1 covering the address electrodes 3. Barrier ribs 7 are formed on the dielectric layer 5. Red (R), green (G), and blue (B) phosphor layers 9 are disposed on a bottom surface 5a and side surfaces 7a of a discharge cell formed between the barrier ribs 7.

Display electrodes 13, each of which includes a transparent electrode 13a and a bus electrode 13b, are disposed in an X-axis direction. The display electrodes 13 are disposed in a direction to cross the address electrodes 3. In addition, a transparent dielectric layer 15 and a protective layer 17 are disposed on the entire surface of the second substrate 11 to cover the display electrodes 13. Each of the discharge cells is formed at positions where the address electrodes 3 cross the display electrodes 13.

The first and second substrates 1 and 11 are sealed with the use of frit. Then, a discharge gas, for example, neon (Ne) and xenon (Xe), is injected into a space between the two substrates.

With the above described structure, address discharge is performed by applying an address voltage to a space between the address electrodes 3 and one of the display electrodes 13. After then, a sustain voltage is applied to a space between a pair of display electrodes 13. As a result, vacuum ultraviolet radiation generated from the sustain discharge excites phosphor layers 9 and thus emit visible light through the second substrate 11.

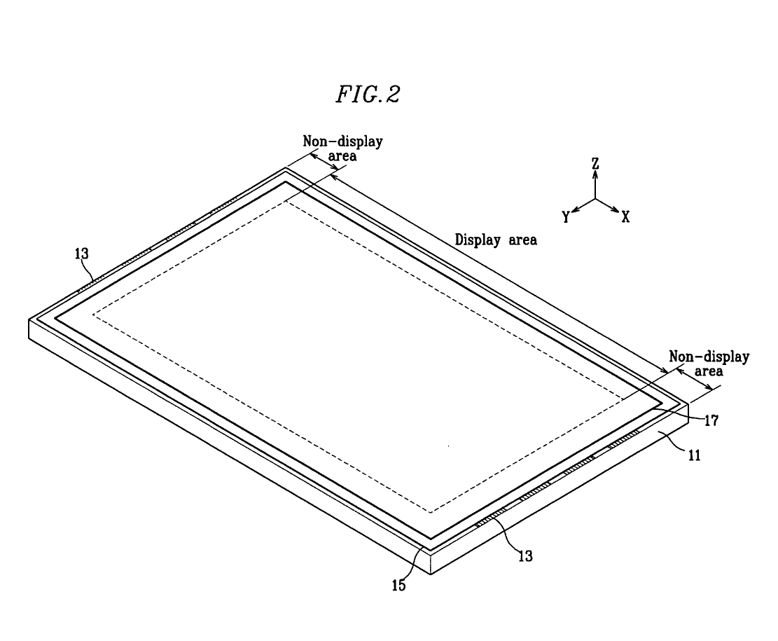

FIG. 2 shows the second substrate 11 including the protective layer 17 which is taken away from the PDP of FIG. 1. The second substrate 11 is rotated by 180° in FIG. 2 in order to explain one embodiment in detail.

As illustrated in FIG. 2, a display area and a non-display area are formed on the substrate 11. The non-display area surrounds the display area. A plurality of discharge cells are formed in the display area.

The second substrate 11 includes a plurality of display electrodes 13, a second dielectric layer 15, and a protective layer 17. These elements are sequentially disposed on the second substrate 11. A plurality of display electrodes 13 are disposed in the X-axis direction of FIG. 2 and the second dielectric layer 15 is disposed on the second substrate 11 to cover the display electrodes 13.

The second dielectric layer 15 is covered with the protective layer 17. The protective layer 17 may contain MgO and an element including at least one of Ca and Fe.

Since the remaining manufacturing steps of a PDP are well known in the art, a detailed description thereof is omitted for convenience.

Hereinafter, experimental examples according to one embodiment of the present invention and comparative examples will be described below. The following examples are merely exemplary and do not limit the scope of protection for the invention.

### EXAMPLES 1 TO 3

Display electrodes including an indium tin oxide were formed on a substrate in a stripe pattern by using a typical method. The substrate is made of soda lime glass. The substrate was coated with a lead-based glass paste and then was baked. Then, a dielectric layer was formed. Subsequently, a protective layer including MgO and Ca was prepared by using a sputtering method and disposed on the dielectric layer.

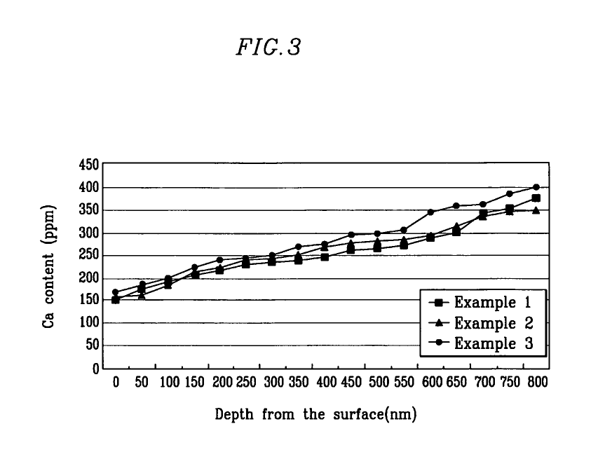

Here, the content of Ca increased in the range of 150 to 402 ppm from the surface of the protective layer toward the dielectric layer as described in Table 1. The increase in the Ca content according to the thickness of the protective layer is shown in FIG. 3.

TABLE 1

| Depth from the | | | |
|---|---|---|---|
| surface | Example 1 | Example 2 | Example 3 |
| 0 nm | 150 | 157 | 167 |
| 50 nm | 174 | 162 | 183 |
| 100 nm | 192 | 183 | 199 |
| 150 nm | 203 | 215 | 225 |
| 200 nm | 216 | 223 | 238 |
| 250 nm | 229 | 241 | 242 |
| 300 nm | 235 | 246 | 251 |
| 350 nm | 239 | 253 | 268 |
| 400 nm | 247 | 268 | 274 |
| 450 nm | 261 | 279 | 295 |
| 500 nm | 265 | 284 | 298 |
| 550 nm | 271 | 288 | 305 |
| 600 nm | 288 | 293 | 345 |
| 650 nm | 300 | 315 | 358 |
| 700 nm | 343 | 337 | 362 |
| 750 nm | 354 | 348 | 384 |
| 800 nm | 376 | 352 | 402 |

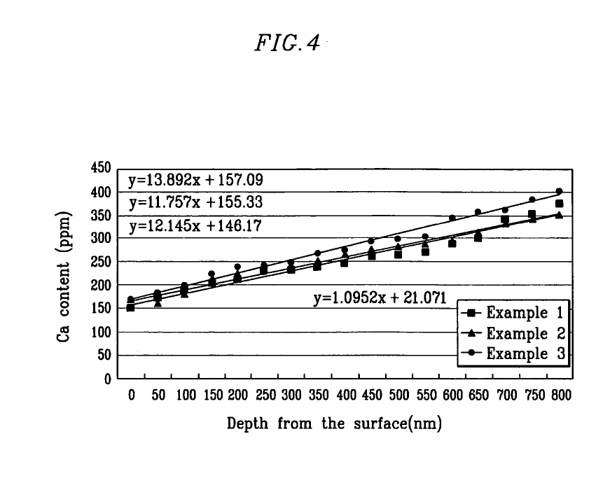

FIG. 4 illustrates the relationship between Ca contents and the surface depth with respect to Examples 1 to 3. Table 2 shows the average Ca content and its standard deviation with respect to the surface and base layers.

The surface layer contacts the discharge cells while the base layer contacts the dielectric layer. As described in Table 2, Ca contents are greater in the base layer than the surface layer.

TABLE 2

| | Average | Standard |
|---|---|---|
| | Content (ppm) | Deviation (StDeV) |
| Surface layer (0 nm) | 158.00 | 8.54 |
| Base layer (800 nm) | 376.7 | 25.0 |

### COMPARATIVE EXAMPLE 1

Comparative Example 1 was obtained by using the same process as that of the Example 1 except that the protective layer is formed on the dielectric layer by sputtering only MgO.

### COMPARATIVE EXAMPLE 2

Comparative Example 2 was obtained by using the same process as that of the Example 1 except that Ca was deposited on the entire protective layer with a uniform content.

Test Results

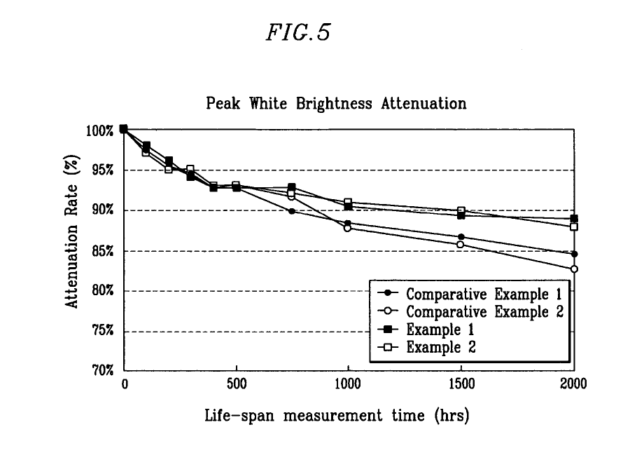

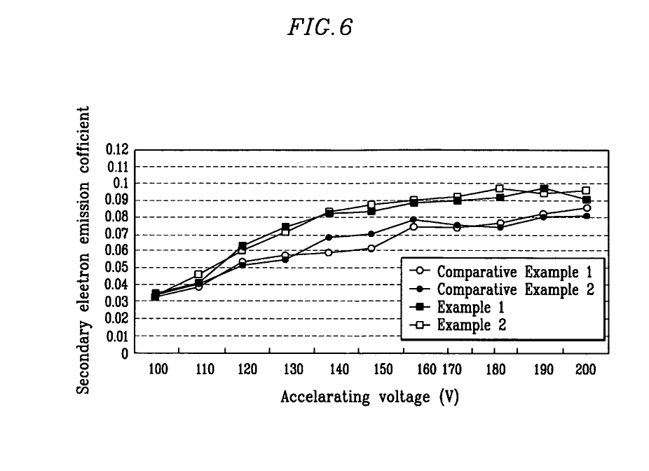

With the protective layers prepared in Examples 1 and 2 and Comparative Examples 1 and 2, life-span characteristics and secondary electron emission characteristics were tested and the results are shown in Tables 3 and 4 and FIGS. 5 and 6, respectively.

TABLE 3

| | Measurement Hours (hr) | | | | | | | | | |
|---|---|---|---|---|---|---|---|---|---|---|
| | 0 | 100 | 200 | 300 | 400 | 500 | 750 | 1000 | 1500 | 2000 |
| Comp. Example 1 | 100% | 97% | 95% | 94% | 93% | 93% | 90% | 88% | 87% | 85% |
| Comp. Example 2 | 100% | 97% | 95% | 94% | 93% | 93% | 92% | 88% | 86% | 83% |
| Example 1 | 100% | 98% | 96% | 94% | 93% | 93% | 93% | 90% | 90% | 89% |
| Example 2 | 100% | 97% | 95% | 95% | 93% | 93% | 92% | 91% | 90% | 88% |

As described in Table 3, with regard to the life-span characteristics, there were no significant differences in attenuation rate between Examples 1 and 2, and Comparative Examples 1 and 2 from 0 to 500 hours. However, in the range of 750 to 2000 hours, the differences became greater. That is, the attenuation rates of the Comparative Examples 1 and 2 more quickly decreased than those of the Examples 1 and 2 in the range of 750 to 2000 hours.

TABLE 4

| | Accelerating Voltage (V) | | | | | | | | | | |
|---|---|---|---|---|---|---|---|---|---|---|---|
| | 100 | 110 | 120 | 130 | 140 | 150 | 160 | 170 | 180 | 190 | 200 |
| Comp. | 0.033 | 0.039 | 0.053 | 0.057 | 0.059 | 0.062 | 0.075 | 0.075 | 0.077 | 0.083 | 0.087 |
| Example 1 | | | | | | | | | | | |
| Comp. | 0.034 | 0.041 | 0.052 | 0.055 | 0.069 | 0.071 | 0.079 | 0.076 | 0.075 | 0.081 | 0.082 |
| Example 2 | | | | | | | | | | | |
| Example 1 | 0.035 | 0.042 | 0.063 | 0.074 | 0.082 | 0.084 | 0.089 | 0.091 | 0.093 | 0.097 | 0.092 |
| Example 2 | 0.034 | 0.046 | 0.061 | 0.072 | 0.084 | 0.088 | 0.091 | 0.093 | 0.098 | 0.095 | 0.097 |

Table 4 also shows that the secondary electron emission coefficient of the Comparative Examples 1 and 2 more quickly increased than those of the Examples 1 and 2 almost in the entire range of the voltage (V).

From the results, it can be seen that the protective layers of Examples 1 and 2 have better life-span and discharge characteristics than those of Comparative Examples 1 and 2.

### EXAMPLES 5 TO 7

In these examples, display electrodes including an indium tin oxide were formed on a substrate in a stripe pattern by using a typical method. The substrate is made of soda lime glass. The substrate was coated with a lead-based glass paste and then was baked. Then, a dielectric layer was formed. Subsequently, a protective layer including MgO and Fe was prepared by using a sputtering method and disposed on the dielectric layer.

Here, the content of Fe increased in the range of 20 to 40 ppm from the surface of the protective layer toward the dielectric layer as described in Table 5. The Fe content according to the depth from the surface of the protective layer is illustrated in FIG. 6.

TABLE 5

| | Thickness of Protective Layer | | | | | | | |
|---|---|---|---|---|---|---|---|---|
| | | 100 | 200 | 300 | 400 | | | |
| | 0 | nm | nm | nm | nm | 500 nm | 600 nm | 700 nm |
| Example 5 | 30 | 33 | 34 | 35 | 38 | 39 | 40 | 42 |
| Example 6 | 31 | 32 | 33 | 33 | 37 | 39 | 41 | 41 |
| Example 7 | 22 | 22 | 24 | 27 | 28 | 28 | 28 | 29 |

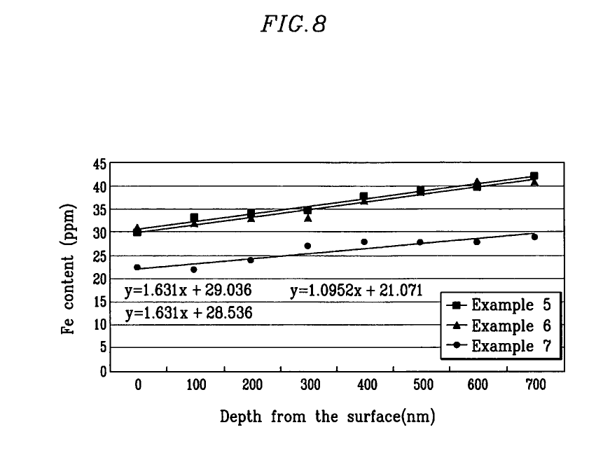

FIG. 8 illustrates the relationship between Fe contents and the surface depth with respect to Examples 5 to 7. Table 6 shows the average Fe content and its standard deviation with respect to the surface and base layers.

The surface layer contacts the discharge cells while the base layer contacts the dielectric layer. As described in Table 6, Fe contents are greater in the base layer than the surface layer.

TABLE 6

| | Average | |
|---|---|---|
| | Content | |
| | (ppm) | Standard Deviation (StDeV) |
| Surface layer (0 nm) | 27.67 | 4.93 |
| Base layer (700 nm) | 37.33 | 7.23 |

### COMPARATIVE EXAMPLE 3

Comparative Example 3 was obtained by using the same process as that of the Example 1 except that Fe was deposited on the entire protective layer in a uniform content.

Test Results

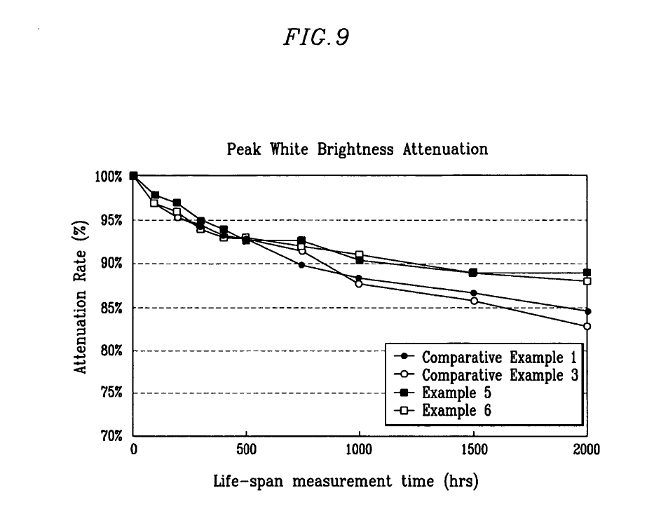

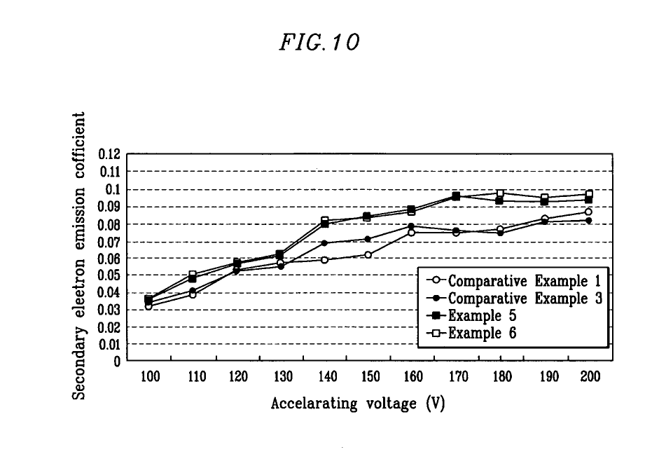

With the protective layers prepared in Examples 5 and 6 and Comparative Examples 1 and 3, life-span characteristics and discharge delay times were tested. The results are shown in Tables 7 and 8 and FIGS. 9 and 10, respectively.

TABLE 7

| | Measurement Hours (hr) | | | | | | | | | |
|---|---|---|---|---|---|---|---|---|---|---|
| | 0 | 100 | 200 | 300 | 400 | 500 | 750 | 1000 | 1500 | 2000 |
| Comp. Example 1 | 100% | 97% | 95% | 94% | 93% | 93% | 90% | 88% | 87% | 85% |
| Comp. Example 3 | 100% | 97% | 95% | 94% | 93% | 93% | 92% | 88% | 86% | 83% |
| Example 5 | 100% | 98% | 97% | 95% | 94% | 93% | 93% | 90% | 89% | 89% |
| Example 6 | 100% | 97% | 96% | 94% | 93% | 93% | 92% | 91% | 89% | 88% |

As in the previous results, Table 7 shows that the attenuation rates of Comparative Examples 1 and 3 more sharply dropped than those of the Examples 5 and 6 as the measurement hours increased.

TABLE 8

| | Accelerating | | | | | | | | | | |
|---|---|---|---|---|---|---|---|---|---|---|---|
| | Voltage (V) | | | | | | | | | | |
| | 100 | 110 | 120 | 130 | 140 | 150 | 160 | 170 | 180 | 190 | 200 |
| Comp. | 0.033 | 0.039 | 0.053 | 0.057 | 0.059 | 0.062 | 0.075 | 0.075 | 0.077 | 0.083 | 0.087 |
| Example 1 | | | | | | | | | | | |
| Comp. | 0.034 | 0.041 | 0.052 | 0.055 | 0.069 | 0.071 | 0.079 | 0.076 | 0.075 | 0.081 | 0.082 |
| Example 3 | | | | | | | | | | | |
| Example 5 | 0.036 | 0.048 | 0.057 | 0.062 | 0.079 | 0.084 | 0.089 | 0.096 | 0.093 | 0.093 | 0.094 |
| Example 6 | 0.036 | 0.051 | 0.058 | 0.063 | 0.082 | 0.083 | 0.087 | 0.095 | 0.098 | 0.095 | 0.097 |

As described in Table 8, the secondary electron emission coefficient of the Comparative Examples 1 and 3 were significantly greater than those of the Examples 5 and 6 throughout the accelerating voltage.

From the results of FIGS. 9 and 10, it can be seen that the protective layers of Examples 5 to 7 that have an increasing Fe content from the surface layer to the base layer are significantly better life-span and discharge characteristics than those of Comparative Examples 1 and 3.

As described above, the PDP in accordance with an embodiment can have excellent anti-sputtering performance and improved electron emission and life-span characteristics. As a result, the display quality is enhanced.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel (PDP), comprising:
first and second substrates spaced apart from each other;
a plurality of address electrodes disposed on the first substrate;
a first dielectric layer disposed on the first substrate while covering the address electrodes;
a plurality of barrier ribs, formed on the first dielectric layer, configured to partition the space between the first and second substrates into a plurality of discharge cells;
a plurality of phosphor layers formed in the discharge cells;
a plurality of display electrodes disposed on the second substrate along a direction crossing the address electrodes;
a second dielectric layer disposed on the second substrate configured to cover the display electrodes; and
a protective layer disposed to cover the second dielectric layer;
wherein the protective layer has MgO and an element including at least one of: Ca and Fe,
wherein the protective layer comprises a surface facing the discharge cells,
wherein the concentration gradient of the element is positive in the direction from the surface of the protective layer toward the second dielectric layer.

2. The PDP of claim 1, wherein the relationship between the content of the element and the thickness of the protective layer is expressed by the following equation:
Y=aX+b
where Y denotes the content of the element, X denotes the thickness of the protective layer, a is in the range of about 11 to about 14, and b is in the range of about 145 to about 160.

3. The PDP of claim 1, wherein the content of the element is in the range of about 20 ppm to about 400 ppm with respect to the entire amount of the protective layer.

4. The PDP of claim 3, wherein the content of the element is in the range of about 20 ppm to about 250 ppm.

5. The PDP of claim 3, wherein the element comprises Ca, and
wherein the content of Ca is in the range of about 150 ppm to about 400 ppm.

6. The PDP of claim 5, wherein the content of Ca is in the range of about 150 ppm to about 250.

7. The PDP of claim 3, wherein the element comprises Fe, and
wherein the content of Fe is in the range of about 20 ppm to about 45 ppm.

8. The PDP of claim 7, wherein the content of Fe is in the range of about 20 ppm to about 30 ppm.

9. The PDP of claim 1, wherein the thickness of the protective layer is in the range of about 500 nm to about 900 nm.

10. The PDP of claim 1, wherein the protective layer comprises:
a first protective layer comprising MgO and the element; and
a second protective layer formed on the first layer.

11. The PDP of claim 10, wherein the second protective layer includes at least one of the following: Si, Al, Fe, Cr and Na.

12. The PDP of claim 1, wherein the protective layer comprises a columnar crystalline structure.

13. The PDP of claim 1, wherein the protective layer is formed by ion bombardment sputtering.

14. The PDP of claim 1, wherein MgO in the protective layer is formed from a polycrystalline magnesium oxide.

15. A plasma display panel, comprising:
first and second substrates spaced apart from each other, wherein an image is configured to be displayed via the second substrate;
a plurality of discharge cells formed between the first and second substrates; and
a protective layer formed between the plurality of discharge cells and the second substrate,
wherein the protective layer is formed from MgO and dopant,
and wherein the content of MgO decreases according to depth from the plurality of the discharge cells to the second substrate.

16. The plasma display panel of claim 15, wherein the content of the dopant gradually increases in the thickness direction.

17. The plasma display panel of claim 16, wherein the dopant comprise at least one of: Ca and Fe.

18. A method of manufacturing a plasma display panel, comprising:
providing a plurality of display electrodes on a substrate;
providing a dielectric layer so as to cover the plurality of electrodes; and
forming a protective layer on the dielectric layer,
wherein the forming comprises depositing materials including MgO and dopant on the dielectric layer while gradually decreasing the concentration of the dopant.

19. The method of claim 18, wherein the relationship between the concentration of the dopant and the thickness of the protective layer is expressed by the following equation:
Y=aX+b
where Y denotes the content of the dopant, X denotes a the thickness of the protective layer, a is in the range of about 11 to about 14, and b is in the range of about 145 to about 160.

20. The method of claim 18, wherein the depositing comprises:
depositing MgO and at least one of: Ca and Fe; and
depositing MgO and at least one of: Si, Al, Fe, Cr and Na.
